(19) United States
(12) Patent Application Publication
(10) Pub. No.: US 2005/0143085 A1
(43) Pub. Date: Jun. 30, 2005

(54) Broadcast/multicast services in wireless communications networks and methods

(76) Inventors: Hao Bi, Wheeling, IL (US); Brian K. Classon, Palatine, IL (US); Mang Zhu, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 10/749,021

(22) Filed: Dec. 30, 2003

(51) Int. Cl. H04Q 7/00

(52) U.S. Cl. 455/452.2

(57) ABSTRACT

A method in wireless communications network infrastructure including transmitting (210) first layer broadcast/multicast service content information on a first channel, and transmitting (220) second layer broadcast/multicast service content information on a second channel, at least one of the first and second channels a shared broadcast channel, wherein the first and second layer broadcast/multicast service content information is related. The information is received and combined (230) at a subscriber device, wherein a least one of the first and second layers capable of being decoded and used without the other of the first and second layers.

### FIELD OF THE DISCLOSURE

The present disclosure relates generally to broadcast/multicast communications, and more particularly to providing broadcast/multicast services to subscriber devices, for example, to wireless subscriber devices in wireless communications networks, and corresponding methods in broadcast/multicast networks and broadcast/multicast subscriber devices.

### BACKGROUND OF THE DISCLOSURE

Broadcast/multicast communication service (BCMCS) is the simultaneous transmission of the same information to multiple recipients. BCMCS transmission on shared data channels is a relatively efficient allocation of radio resources in comparison to using multiple dedicated channels to communicate the same information to multiple recipients. Any data may be transmitted in broadcast/multicast service, including but not limited to text, multimedia, streaming media, etc.

Some wireless communications standards organizations have adopted protocols for providing broadcast/multicast services to mobile subscriber devices in wireless communications networks. The 3^{rd} Generation Partnership Project 2 (3GPP2), for example, has defined the functionality of broadcast multicast services that may be incorporated in to CDMA2000 based wireless telecommunications networks in the Broadcast/Multicast Services—Stage 1, Revision A, 3GPP2 S.R0030-A, Version 1.0. Other standards may specify the broadcast multicast functionality for other wireless communications protocols.

In some High Rate Packet Data (HRPD) networks, for example, CDMA2000 HRPD, which is standardized as 1×EV-DO, there is only one shared data channel (to which all base station power is allocated) available for BCMCS transmissions. In these systems, all BCMCS subscribers, e.g., wireless mobile stations, receive data the same rate or at the same level of information transmission, e.g., at the same quality of service. In 3^{rd} Generation (3G) Universal Mobile Telephone System (UMTS) WCDMA networks, BCMCS transmission rates are fixed and not adjustable. Thus UMTS W-CDMA systems are not able to compensate for system load and channel conditions by adjusting the BCMCS transmission rate to subscribers.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is a schematic diagram of a wireless communications network supporting broadcast multicast services (BCMCS) to wireless subscriber devices.

FIG. 2 is an exemplary process flow diagram for transmitting and receiving broadcast/multicast information.

### DETAILED DESCRIPTION

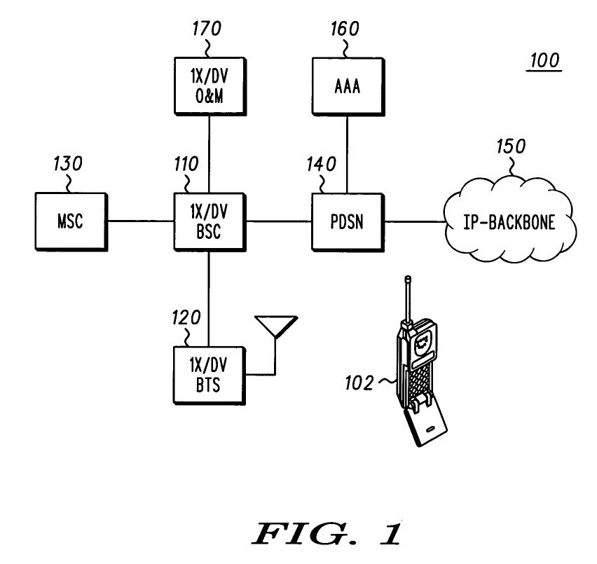

FIG. 1 illustrates an exemplary CDMA 2000 1× Evolution for Data and Voice (1×EV-DV, also known as CDMA2000, release C) services wireless communications network 100 comprising generally a base station controller (BSC) 110 communicably coupled to one or more base transceiver stations (BTS) 120 and to a mobile switching center (MSC) 130. The exemplary network 100 also comprises a Packet Data Serving Node (PDSN) 140 communicably coupled to an IP backbone 150 or to some other network. The exemplary PDSN is also communicably coupled to an Authentication, Authorization and Accounting (AAA) entity 160, and the BSC 110 is communicably coupled to a 1× Evolution—DV Operations and Maintenance (O&M) entity 170. In other embodiments, more generally, the network is some other network that provides broadcast/multicast services, for example, a CDMA2000 High Rate Packet Data (HRPD) network, or some other network. CDMA HRPD was known formerly as CDMA 1× Evolution-Data Only (1×EV-DO) and High Data Rate (HDR) (high-speed data-only version CDMA network). Although the exemplary network infrastructure architecture is wireless, the disclosure may also be applicable to wire-line broadcast/multicast service applications.

In the exemplary wireless communications system, the broadcast/multicast service is originated from a content server. In some networks, the content server is part of the base-transceiver station 120 in

FIG. 1, but more generally the content server is a network entity that communicates with the base transceiver station 120. The content server may be located at a base station controller, at a network controller, or at some other network entity, or it may be a standalone server attached to the network. Broadcast/multicast services may also be are provided by servers in networks other than wireless communications networks.

In FIG. 1, an exemplary wireless broadcast/multicast subscriber device 102 receives broadcast/multicast services from one or more base stations, for example the exemplary base transceiver station 120 in FIG. 1, depending, on whether the wireless subscriber device 102 is mobile or stationary. In other embodiments, the broadcast/multicast subscriber device is not necessarily a wireless device.

Many broadcast/multicast service applications may be communicated using multilevel transmission schemes, examples of which are discussed below. In some broadcast/multicast services applications, the content comprises multiple layers of related information transmitted separately. In one embodiment, for example, a first broadcast/multicast information layer corresponds to audio content and a second layer corresponds to video content related to the audio content. In another application, content, for example, a web page, is parsed into headline information corresponding to baseline level information. The exemplary web page may also be parsed into full text corresponding to enhancement level information, and into graphical information, which corresponds to elite level information. Multilevel transmission is also suitable for transmission of packets of scalable picture codec. Scalable picture codec generates packets corresponding to different levels of picture detail. A picture having finer detail, i.e., greater resolution, is obtained by combining lower resolution picture packets with packets containing additional picture detail. In other embodiments, one or more layers of broadcast/multicast information comprise reliability or redundancy information, examples of which are also discussed further below, associated with or related to content information of another layer.

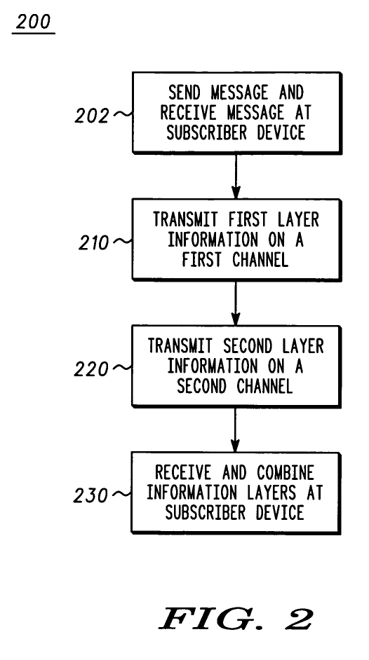

In one embodiment, illustrated by the exemplary process diagram 200 of FIG. 2, beginning at block 210, first layer broadcast/multicast service information is transmitted on a first channel and, at block 220, second layer broadcast/multicast service information is transmitted on a second channel. In other embodiments, additional information is transmitted on other channels.

In many applications, while the multiple broadcast/multicast service information layers are related, as suggested above, at least one of the multiple information layers is capable of being decoded and used without the other layers. In the audio/video example discussed above, for example, the audio information could be received and decoded by a subscriber device, without the video information. In other embodiments, however, one or more information layers may be dependent on the other layers, for example, where one or more of the additional information layers comprise redundancy information for another layer containing content. In FIG. 2 at block 230, the subscriber receives multiple layer content from the base station and combines the content for consumption by the subscriber. Thus in some embodiments, at least one of the layers is capable of being decoded and used without the other layers, so the combining operation may be able to produce content for consumption by the consumer without receiving all of the layers that were transmitted. A layer that was transmitted may not be available to a subscriber device for a variety of reasons, for example, the layer may not have been received or it may have been corrupted. Also, the subscriber device may not have received a control message specifying where, e.g., on which channel, the layer was to be received, or the subscriber device may not have access to the layer, or the subscriber may have lost or corrupted an encryption key required for accessing the layer in applications where it is encrypted.

In one embodiment, the first and second layer broadcast/multicast service content information is transmitted from the same source, for example, from a common base transceiver station (BTS) 120 in FIG. 1. In other embodiments, separate transmitters, located at a common location or at different locations, transmit corresponding layers of the multi-layer information.

In one application, the first layer broadcast/multicast service information is transmitted on a shared channel, and the second layer broadcast/multicast service information is transmitted on a dedicated channel. An exemplary scenario where this type of transmission is appropriate is where the baseline level content is transmitted on the shared channel, and enhancement content is transmitted on multiple dedicated channels to corresponding subscribers. The use of multiple dedicated channels may be appropriate where the number of enhancement level subscribers does not justify shared channel transmission and/or where the dedicated transmissions do not overburden network resources. In other embodiments, both the related information layers, e.g., the exemplary audio and video layers, are transmitted on shared channels. In some embodiments, a layer on a shared channel could be also made available to some subscribers on corresponding dedicated channels. An exemplary scenario is when this may occur is where certain subscribers have substantially better or worse channel conditions than the average broadcast subscriber, or the resources consumed or the information provided via the shared channels can be reduced or increased, respectively.

In some embodiments, the first and second layer broadcast/multicast service information is transmitted substantially simultaneously. In the audio/video example discussed above, the audio layer broadcast/multicast content and video second layer broadcast/multicast service content are transmitted with sufficient temporal proximity to enable substantially synchronized integration of the audio and video content by a recipient subscriber device. In this exemplary case, substantially simultaneously means that there is no more delay than would result is an unacceptable lack of audio and video synchronization at the subscriber device upon combining the audio and video information. For example, users may tolerate less audio video synchronization on smaller, relatively low-resolution displays than users of relatively high-resolution displays. Thus at least for some content that is combined for consumption by the recipient subscriber device, more or less synchronization is tolerable, depending on the particular application and on the circumstances under which it is consumed, among other factors. Thus while the process diagram 200 of FIG. 2 suggests sequential transmission of the multiple information layers at block 210 and 220, in at least some applications, these information layers are transmitted substantially simultaneously.

Other applications may not require simultaneous transmission. In the scalable picture packet example comprising layers having different levels of picture detail, basic level detail can be broadcast or multicast to a large group of subscribers, and finer detail can be multicast or transmitted dedicatedly to a sub-group of subscribers. A picture having finer details or higher resolution may be obtained by combining lower resolution picture packets with packets containing additional details. In this exemplary embodiment, it may not be necessary in at least some instances to transmit the picture packet layers simultaneously. For example, the high and low-resolution packet layer may be sequentially transmitted and stored on the subscriber device for combination or integration at a later time. In other embodiments picture packet layer information may be transmitted simultaneously if desired.

In another embodiment, content and reliability information are transmitted on a first channel, for example, at block 210 in FIG. 2, and additional reliability information for the content is transmitted on a second channel, for example, at block 220 in FIG. 2, wherein the reliability and additional reliability information is for decoding the content. Generally, at least one of the information layers is transmitted on a shared channel. In one particularly application, for example, the content may be transmitted on a shared channel, and the additional reliability information may be transmitted on a shared or on a dedicated channel.

Generally, any redundant decoding information is transmitted substantially simultaneously with the corresponding content, and more particularly, content and additional reliability information are transmitted with sufficient temporally proximity to enable decoding of the content by a recipient subscriber device using the reliability and additional reliability information. In FIG. 2, the subscriber receives and combines content and redundancy information with additional redundancy information at block 230. In some embodiments, the subscriber device may compensate for a lack of synchronicity between the content and additional reliability information by buffering the information upon receipt. Under these circumstances, the available buffer size limits the extent to which the content and the reliability information may be unsynchronized.

Multilevel transmission of redundancy information can be used to provide different levels of quality of service (QoS), for example, different frame error rates (FER) may be provided to different subscribers. This can be achieved by sending subscribers the same content information, but with different levels of error correction coding. For example, an information packet can be encoded using a ¼ turbo code for error correction. In one embodiment, for example, systematic bits and one third of the parity bits, which constitute baseline information, are transmitted on a Forward Packet Data Channel (F-PDCH) to all subscribers as a broadcast/multicast service. The remaining two thirds of the parity bits, which constitute an enhanced level of information, are transmitted on the second F-PDCH to a sub-group of subscribers as a multicast service. Subscribers of the baseline and enhanced information will have lower FER than subscribers of only the baseline information. Additionally, a subset of encoded bits can be sent to subscribers using a dedicated data channel. By combining the transmission on its dedicated channels with the baseline on the first F-PDCH and/or enhanced level on the second F-PDCH, the FER may be reduced further.

In some embodiments, access to the different information layers may be controlled or limited by encrypting some or all of the information layers before transmission. In one embodiment, for example, at least one of information layers of the broadcast/multicast service is encrypted before transmission. For example, baseline level information may be unencrypted, but enhanced level information may be encrypted. Access to the enhancement level information is limited to subscribers having a key required for decrypting the enhanced information. In other embodiments, more than one layer of broadcast/multicast service content information is encrypted. In this latter exemplary embodiment, access to the different layers is limited to subscribers having the necessary decryption keys. The decryption keys may be obtained at the time of the subscription or at a later time, for example in a message communicated securely. In exemplary schematic process diagram of FIG. 2, any required decryption occurs at block 230.

In some embodiments, each layer of the multi-layer broadcast/multicast service information is transmitted using different parameters. For example, first layer broadcast/multicast service information may be transmitted using a first transmission parameter, and second layer broadcast/multicast service information may be transmitted using a second transmission parameter, which is generally different than the first transmission parameter. Exemplary parameters include, among others, transmission at different power levels, different bandwidth, transmission using different coding rates, different modulation schemes, etc.

In some embodiments, indicated in FIG. 2, at block 202, the network base station sends a message to the subscriber devices indicating on which channel at least one of the information layers is being transmitted. Where one of the layers, for example, enhanced content or additional decoding information, is transmitted one a dedicated channel, the network may send a message to a subgroup of subscribers identifying the dedicated channel on which the information is available may be received. Thus in FIG. 2, at block 202, the subscriber device receives a message identifying the channel on which content will be transmitted, or some other information required for receiving or decoding the information.

Some information required by the subscriber device for receiving or decoding the multi-layer information could be determined by the base transceiver station itself, especially when one of the channels used is a shared packet data channel where the resources for the broadcast service may be changing from frame to frame. Such information could include the set of Walsh codes used for the transmission, or information used to compute the coding rate and modulation used for the transmission, or any other transmitter parameter as identified above.

Several exemplary embodiments are described below. The exemplary embodiments include a number of examples that send multiple layers of information on multiple shared channels (e.g., F-PDCH). Other examples, not described, could use the F-PDCH channel and another channel in 1×EV-DV, such as a dedicated channel or a shared channel. For the examples below, a control message, sent to subscribers, provides information on which channels to find the services on and the keys required (if any) to decrypt the services. In some embodiments, additional control messaging, related to parameters required for decoding, is sent via a F-PDCCH. The F-PDCCH control channel bits are reinterpreted for a broadcast environment by reserving a single reserved MAC_ID for the multi-layer broadcast/multicast service (e.g., 00000001). Different layers of service will be identified by combinations of the F-PDCCH 2 bit ACID (ARQ Channel ID for multi-phase ARQ process), 2 bit SPID (Sub-packet ID for HARQ redundancy version), and 1 bit AI_SN (ARQ identifier sequence number). None of these fields are required for broadcast/multicast service, since there is no feedback and therefore no ARQ process. Which fields or combination of fields to identify the different layers of the service may be specified in the a control message which provides information on which channels to find the services on and the keys required (if any) to decrypt the services. Mappings between signaling bits (ARQ channel ID and/or incremental redundancy version) and the layers may also be defined a priori, (say one layer per ARQ channel ID) to save signaling overhead. New broadcast service control channels, with equivalent functionality but different field names, could also be created. For example, the fields could be renamed (e.g. change ACID to channel identifier (CID), the number of bits in each field changed, and fields could be combined to create a larger field (e.g., if reliability layers via incremental redundancy are not needed the SPID bits can be put into a larger ACID). The number of different layers that can be received during a common frame may be limited by the number of F-PDCCHs that can currently be received (e.g., two). In these cases, the different layers may be sent in different frames, with the frames typically (though not always) within a few frames of the base layer. The number of control channels that can be received during a particular frame may be increased to accommodate additional broadcast services.

### EXAMPLE 1

The 2-bit ACID is used to differentiate up to 4 different layers for potential transmission and billing differences, for example, the layer ID is the ACID. Up to 4 different keys may be provided. HARQ storage from the non-broadcast services is not required or used. Because the layers are on different ACID, the encoder packet size F-PDCCH control field (N_EP) need not be the same between layers. For example, one layer (e.g., voice) sent with ACID 00, N_EP=408 bits, 19 Walsh codes, code rate=0.2237, one slot, and QPSK modulation. Another layer (e.g., video) is sent in the same or a different frame with ACID 01, N_EP=792, 7 Walsh codes, code rate 0.5893, one slot, and 16QAM modulation. Users may receive only the voice key (applied to channels with ACID 00) or the voice key and the video key (applied to channels with ACID 01) depending on the operator's business model. A single key for both could be used if the operator did not want to charge differently, but only wanted to provide the base layer to all and to efficiently provide the extra layer to those in good conditions. Table I below illustrates Example 1.

TABLE I

| ACID | SPID | N_EP | L | Action |
|---|---|---|---|---|
| 00 | 00 | X | 0 | new layer 0 packet X |
| 00 | 01 | X | 0 | more redun for X |
| 00 | 10 | X | 0 | more redun for X |
| 00 | 11 | X | 0 | more redun for X |
| 01 | 00 | Y | 1 | new layer 1 packet Y |
| 01 | 01 | Y | 1 | more redun for Y |
| 01 | 10 | Y | 1 | more redun for Y |
| 01 | 11 | Y | 1 | more redun for Y |

Etc for ACID = 10, 11, layer 2 and 3 packets

### EXAMPLE 2

The 2-bit SPID is used to differentiate up to 4 different layers for potential transmission and billing differences. Up to 4 different keys may be provided. The ACID is not needed. HARQ storage from the non-broadcast services is used in the amount of one HARQ channel. Because the layers are on the same effective ACID (whether the ACID is set to the same value or just ignored), the N_EP must be the same between layers. In addition, the extra “layer” in this case is increased reliability of reception of both layers. Example: video is sent with SPID 00, N_EP=3096 bits, 19 Walsh codes, code rate=0.5658, 2 slots, and 8PSK modulation. Redundancy is sent in the same or a different frame with SPID 01, N_EP=3096, 7 Walsh codes, code rate 0.5759, 4 slots, and 16QAM modulation. If SPID 00 indicates a new packet, the other SPID are always jointly decoded with the previous or simultaneously received SPID 00. Users may receive only the base key (applied to channels with SPID 00) or the base key and the improved key (applied to channels with SPID 01) depending on the operator's business model. A single key for both could be used if the operator did not want to charge differently, but only wanted to provide the base quality to all and to efficiently provide the extra quality to those in good conditions. Table II below illustrates Example 2.

TABLE II

| SPID | N_EP | L | Action |
|---|---|---|---|
| 00 | X | 0 | new layer 0 packet X |
| 01 | X | 1 | more redun for X |
| 10 | X | 2 | more redun for X |
| 11 | X | 3 | more redun for X |

### EXAMPLE 3

A combination of ACID and SPID are used to define up to 16 different layers. Many different mappings between layers (and keys) with ACID/SPID are possible. A three-layer example is shown below.

TABLE III

| ACID | SPID | N_EP | L | Action |
|---|---|---|---|---|
| 00 | 00 | X | 0 | new layer 0 packet X |
| 00 | 01 | X | 1 | more redun for X |
| 00 | 10 | X | 1 | more redun for X |
| 00 | 11 | X | 1 | more redun for X |
| 01 | 00 | Y | 2 | new layer 2 packet Y |
| 01 | 01 | Y | 2 | more redun for Y |
| 01 | 10 | Y | 2 | more redun for Y |
| 01 | 11 | Y | 2 | more redun for Y |

Examples 1 to 3 above each used a SPID 00 to identify a new packet. If the AI_SN is used, repeats of a packet can be sent and combined using SPID 00 and Al_SN that indicates the same packet. The non-00 SPID can be jointly decoded with the previous or simultaneously received SPID 00 with the same Al_SN. Revised Tables for the alternative to Examples 1 to 3 are provides below.

Table IV below illustrates the alternative to Example 1.

TABLE IV

| ACID | SPID | AI_SN | N_EP | L | Action |
|---|---|---|---|---|---|
| 00 | 00 | new | X | 0 | new layer 0 packet X |
| 00 | 00 | old | X | 0 | repeat of X |
| 00 | 01 | old | X | 0 | more redun for X |
| 00 | 10 | old | X | 0 | more redun for X |
| 00 | 11 | old | X | 0 | more redun for X |
| 01 | 00 | new | Y | 1 | new layer 1 packet Y |
| 01 | 00 | old | Y | 1 | repeat of Y |
| 01 | 01 | old | Y | 1 | more redun for Y |
| 01 | 10 | old | Y | 1 | more redun for Y |
| 01 | 11 | old | Y | 1 | more redun for Y |

Etc for ACID = 10, 11, layer 2 and 3 packets

Table V below illustrates the alternative to Example 2.

TABLE V

| ACID | SPID | AI_SN | N_EP | L | Action |
|---|---|---|---|---|---|
| 00 | 00 | new | X | 0 | new layer 0 packet X |
| 00 | 00 | old | X | 0 | repeat of X |
| 00 | 01 | old | X | 1 | more redun for X |
| 00 | 10 | old | X | 2 | more redun for X |
| 00 | 11 | old | X | 3 | more redun for X |

Table VI below illustrates the alternative to Example 3.

TABLE VI

| ACID | SPID | AI_SN | N_EP | L | Action |
|---|---|---|---|---|---|
| 00 | 00 | new | X | 0 | new layer 0 packet X |
| 00 | 00 | old | X | 1 | repeat of X |
| 00 | 01 | old | X | 1 | more redun for X |
| 00 | 10 | old | X | 1 | more redun for X |
| 00 | 11 | old | X | 1 | more redun for X |
| 01 | 00 | new | Y | 2 | new layer 2 packet Y |
| 01 | 00 | old | Y | 2 | repeat of Y |
| 01 | 01 | old | Y | 2 | more redun for Y |
| 01 | 10 | old | Y | 2 | more redun for Y |
| 01 | 11 | old | Y | 2 | more redun for Y |

While the present disclosure and what the best modes of the inventions have been described in a manner establishing possession thereof by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in wireless communications network infrastructure, the method comprising:
transmitting first layer broadcast/multicast service content information on a first channel;
transmitting second layer broadcast/multicast service content information on a second channel,
at least one of the first and second channels a shared broadcast channel,
the first layer broadcast/multicast service content information related to the second layer broadcast/multicast service content information,
at least one of the first and second layers capable of being decoded and used without the other of the first and second layers.

2. The method of claim 1, transmitting the first and second layer broadcast/multicast service content information from a common source.

3. The method of claim 1, transmitting a message identifying at least one of the first and second channels before transmitting the first and second layer broadcast/multicast service content information.

4. The method of claim 1,
transmitting the first layer broadcast/multicast service content information and transmitting the second layer broadcast/multicast service content information substantially simultaneously.

5. The method of claim 1,
transmitting the first layer broadcast/multicast service content information and transmitting the second layer broadcast/multicast service content information with sufficient temporal proximity to enable substantially synchronized integration of the first and second layer broadcast/multicast service content information by a recipient.

6. The method of claim 1,
transmitting the first layer broadcast/multicast service content information on the first channel by transmitting the first layer broadcast/multicast service content information on the shared channel;
transmitting the second layer broadcast/multicast service content information on the second channel by transmitting the second layer broadcast/multicast service content information on a dedicated channel.

7. The method of claim 4, transmitting third layer broadcast/multicast service content information on a second shared channel, the third layer broadcast/multicast service content information related to the first second layer content information.

8. The method of claim 1, transmitting reliability information on a third channel, the reliability information for decoding at least one of the first and second layer broadcast/multicast service content information.

9. The method of claim 1,
the first layer broadcast/multicast service content information is baseline broadcast/multicast service information transmitted on a shared broadcast channel;
the second layer broadcast/multicast service content information is baseline broadcast/multicast service enhancement information transmitted on one of a second shared broadcast channel or a dedicated channel.

10. The method of claim 1,
encrypting at least one of the first and second layer broadcast/multicast service content information before transmitting.

11. The method of claim 1, encrypting the first and second layer broadcast/multicast service content information using different encryption keys before transmitting.

12. The method of claim 2,
transmitting the first layer broadcast/multicast service content information using a first transmission parameter;
transmitting the second layer broadcast/multicast service content information using a second transmission parameter different than the first transmission parameter.

13. A method in wireless communications network, the method comprising:
transmitting content and reliability information on a first channel;
transmitting additional reliability information for the content on a second channel,
the reliability and additional reliability information for decoding the content.

14. The method of claim 13, transmitting the content, the reliability information and the additional reliability information with sufficient temporally proximity to enable decoding of the content, by a recipient, using the reliability and additional reliability information.

15. The method of claim 13,
transmitting the content and reliability information on the first channel includes transmitting the broadcast/multicast service content and reliability information on a shared broadcast channel,
transmitting additional broadcast/multicast service content on a dedicated channel,
the broadcast/multicast service content and reliability information and the additional broadcast/multicast service content transmitted at substantially the same time.

16. The method of claim 13,
transmitting the content and reliability information on a shared channel;
transmitting additional reliability information for the content on a dedicated channel.

17. The method of claim 13,
transmitting the content and reliability information on a shared channel;
transmitting additional reliability information for the content on another shared channel.

18. The method of claim 13,
transmitting the content and reliability information using a first transmission parameter;
transmitting the additional reliability information using a second transmission parameter different than the first transmission parameter.

19. The method of claim 13,
transmitting the content and reliability information on a first channel substantially simultaneously with transmitting the additional reliability information for the content on the second channel.

20. A method in wireless communications device, the method comprising:
receiving a message identifying a channel on which content will be transmitted;
receiving first layer content information on a first channel;
receiving second layer content information on a second channel,
at least one of the first and second channels identified in the message.

21. The method of claim 20, combining the first and second layer content at the wireless subscriber device.

22. The method of claim 20,
the wireless communications device is a broadcast/multicast subscriber device,
receiving first layer content information includes receiving first layer broadcast/multicast content information;
receiving second layer content information includes receiving second layer broadcast/multicast content information.

23. The method of claim 22,
receiving first layer content information on a first channel includes receiving the first layer content information on a first broadcast channel.

24. The method of claim 20,
the first and second layer content information is encrypted,
decrypting the first layer content information with a first key,
decrypting the second layer content information with a second key that is different than the first key.

25. The method of claim 20,
at least one of the first and second layer content information is encrypted,
receiving at least one decryption key for the at least one decrypted first and second layer content information,
decrypting the at least one decrypted first and second layer content information with the decryption key.

26. A method in broadcast/multicast subscriber device, the method comprising:
receiving first layer content information on a first channel;
receiving second layer content information on a second channel,
at least one of the first and second channels a shared broadcast channel,
receiving the first layer content information and the second layer content information substantially simultaneously,
integrating the first and second layer content information at the wireless communications device.
